(19) United States
(12) Patent Application Publication
(10) Pub. No.: US 2026/0281377 A1
(43) Pub. Date: Sep. 17, 2026

(54) QUALITY METRICS

(71) Applicant: Nokia Technologies Oy, Espoo (FI)

(72) Inventors: Thibaud Biatek, Massy (FR); Jill Boyce, Portland, OR (US); Miska Matias Hannuksela, Tampere (FI)

(21) Appl. No.: 19/560,925

(22) Filed: Mar. 9, 2026

Related U.S. Application Data
(60) Provisional application No. 63/771,853, filed on Mar. 14, 2025.

(51) Int. Cl. H04N 19/154; H04N 19/17

(52) U.S. Cl. CPC H04N 19/154; H04N 19/17

(57) ABSTRACT

An apparatus comprising: at least one processor: and at least one memory storing instructions that, when executed by the at least one processor, cause the apparatus at least to perform: defining or generating an information message for enabling a region-based signaling of quality metric: and when the region-based signaling of the quality metric is enabled, signaling one or more of following: a number of regions in a picture: type of regions: region index method indicator for the regions: a region index for each region: or a measure or value for each quality metric and/or each color component of the each region.

### TECHNICAL FIELD

The examples and non-limiting embodiments relate generally to using quality metrics in video processing.

### BACKGROUND

It is known to provide standardized formats for quality metrics in video processing.

### SUMMARY

Example 1: An apparatus comprising: at least one processor; and at least one memory storing instructions that, when executed by the at least one processor, cause the apparatus at least to perform; defining or generating an information message for enabling a region-based signaling of quality metric; and when the region-based signaling of the quality metric is enabled, signaling one or more of following: a number of regions in a picture; type of regions; region index method indicator for the regions; a region index for each region; or a measure or value for each quality metric and/or each color component of the each region.

Example 2: The apparatus example 1, wherein the apparatus is further caused to perform: signaling a flag for indicating whether the region-based signaling of the quality metrics is activated or not.

Example 3: The apparatus of any of the examples 1 or 2, wherein the apparatus is further caused to perform: signaling a region type indicator for indicating the type of regions used.

Example 4: The apparatus of any of the examples 1 to 3, wherein the type of regions comprise: one or more picture partitions that are used for partitioning a coded picture; one or more regions defined by other one or more information messages; explicitly signaled rectangles; or polygonal shapes with multiple nodes.

Example 5: The apparatus example 4, wherein the one or more picture partitions comprises: a subpicture, a slice, or a tile.

Example 6: The apparatus of any of the examples 4 or 5, wherein the one or more regions defined by other one or more information messages comprises constituent rectangles, object mask information, or annotated regions, packed regions information, or regional nesting.

Example 7: The apparatus of any of the examples 3 to 6, wherein the region type indicator comprises a region type indicator value intended to be used to determine whether one or more subsequent indicators that define the region are signaled.

Example 8: The apparatus of example 7, wherein when: the region type indicator value indicates that the type of regions used comprise the subpicture, and wherein the apparatus is further caused to perform: signaling a subpicture index; the region type indicator value indicates that the type of regions used comprise the slice, and wherein the apparatus is further caused to perform: signaling a slice index; the region type indicator value indicates that the type of regions used comprise the tile, and wherein the apparatus is further caused to perform: signaling a tile index; the region type indicator value indicates that the type of regions used comprise the constituent rectangles, and wherein the apparatus is further caused to perform: signaling a constituent rectangles index; or the region type indicator value indicates that the type of regions used comprise explicitly signaled rectangles, and wherein the apparatus is further caused to perform: signaling co-ordinates, a width, and a height of the region.

Example 9: The apparatus of any of the examples 7 or 8, wherein the region type indicator value indicates whether a region is defined by another information message and gates one or more subsequent indicators that identify the another information message that defines the region.

Example 10: The apparatus of any of the examples 1 to 7, wherein: when the region index method indicator is equal to a first value, it indicates that the quality metric is applicable for all the regions; when the region index method indicator is equal to a second value, and wherein the apparatus is further caused to perform: signaling a subset of the number of regions; and signaling a region index for each region; and wherein when the region index method indicator is equal to a third value, and wherein the apparatus is further caused to perform: signaling a region index for each of the regions except for a first region, and wherein the first region is intended to be derived to comprise remaining samples in a decoded picture not comprised in a second region with a different region index as compared to a region index of the first region. In an example, the first value comprises zero or is equal to zero; the second value comprises one or is equal to one; and the third value comprises two or is equal to two. In an example, the second region includes multiple other signaled regions. In an example, the first region comprises a particular region and the different region index comprises a lower region index.

Example 11: The apparatus of any of the examples 1 to 7, wherein the apparatus is further caused to perform: indicating that the quality metric is applicable for all the regions; signaling a subset of the number of regions and a region index for each region; or signaling a region index for each of the regions except for a first region, and wherein the first region is intended to be derived to comprise remaining samples in a decoded picture not comprised in a second region with a different region index compared to a region index of the first region. In an example, the second region includes multiple other signaled regions. In an example, the first region comprises a particular region and the different region index comprises a lower region index.

Example 12: The apparatus of any of the examples 1 to 9, wherein the apparatus is further caused to perform: signaling a region identifier for each region, wherein the region identifier enables tracking of the regions across a sequence of multiple pictures.

Example 13: The apparatus of any of the previous examples, wherein the apparatus is further caused to perform: signaling the information message.

Example 14: The apparatus of any of the previous examples, wherein the information message comprises a supplemental enhancement information message.

Example 15: An apparatus comprising: at least one processor; and at least one memory storing instructions that, when executed by the at least one processor, cause the apparatus at least to perform; receiving an information message enabling region-based processing of quality metric; parsing the information message; and when region-based processing of the quality metric is enabled, extracting one or more of following from the information message; a number of regions in a coded picture; type of regions; region index method indicator for the regions; a region index for each region; or measure or value for each quality metric and/or each color component of the each region.

Example 16; The apparatus of example 15, wherein the apparatus is further caused to perform: receiving the coded picture; decoding the coded picture to generate a decoded picture; selecting one or more regions in the decoded picture for postprocessing; using the quality metric for indicating a lower quality for the selected one or more regions than quality for the other regions in the decoded picture; and applying postprocessing to the selected one or more regions.

Example 17: The apparatus any of the examples 15 or 16, wherein the apparatus is further caused to perform: receiving a flag for indicating whether the region-based signaling of the quality metrics is activated or not.

Example 18: The apparatus of any of the examples 15 to 17, wherein the apparatus is further caused to perform: receiving a region type indicator for indicating the type of regions used.

Example 19: The apparatus of any of the examples 15 to 18, wherein the type of regions comprise: one or more picture partitions that are used for partitioning a coded picture; one or more regions defined by other one or more information messages; explicitly signaled rectangles; or polygonal shapes with multiple nodes.

Example 20: The apparatus example 19, wherein the one or more picture partitions comprises: a subpicture, a slice, or a tile.

Example 21: The apparatus of any of the examples 19 or 20, wherein the one or more regions defined by other one or more information messages comprises constituent rectangles, object mask information, or annotated regions, packed regions information, or regional nesting.

Example 22: The apparatus of any of the examples 18 to 21, wherein the region type indicator comprises a region type indicator value, and wherein the apparatus is further caused to perform: using the region type indicator value for determining whether one or more subsequent indicators that define the region are signaled.

Example 23: The apparatus of example 22, wherein when: the region type indicator value indicates that the type of regions used comprise the subpicture, and wherein the apparatus is further caused to perform: receiving a subpicture index; the region type indicator value indicates that the type of regions used comprise the slice, and wherein the apparatus is further caused to perform: receiving a slice index; the region type indicator value indicates that the type of regions used comprise the tile, and wherein the apparatus is further caused to perform: receiving a tile index; the region type indicator value indicates that the type of regions used comprise the constituent rectangles, and wherein the apparatus is further caused to perform: receiving a constituent rectangles index; or the region type indicator value indicates that the type of regions used comprise explicitly signaled rectangles, and wherein the apparatus is further caused to perform: receiving co-ordinates, a width, and a height of the region.

Example 24: The apparatus of any of the examples 22 or 23, wherein the region type indicator value indicates whether a region is defined by another information message and gates one or more subsequent indicators that identify the another information message that defines the region.

Example 25: The apparatus of any of the examples 15 to 22, wherein: when the region index method indicator is equal to a first value, it indicates that the quality metric is applicable for all the regions; when the region index method indicator is equal to a second value, and wherein the apparatus is further caused to perform: signaling a subset of the number of regions; and signaling a region index for each region; and wherein when the region index method indicator is equal to a third value, and wherein the apparatus is further caused to perform: signaling a region index for each of the regions except for a first region, and wherein the apparatus is further caused to perform: deriving the first region to comprise remaining samples in a decoded picture not comprised in a second region with a different region index as compared to a region index of the first region. In an example, the first value comprises zero or is equal to zero; the second value comprises one or is equal to one; and the third value comprises two or is equal to two. In an example, the second region includes multiple other signaled regions. In an example, the first region comprises a particular region and the different region index comprises a lower region index.

Example 26: The apparatus of any of the examples 15 to 22, wherein the apparatus is further caused to perform: receiving an indication that the quality metric is applicable for all the regions; receiving a subset of the number of regions and a region index for each region; or receiving a region index for each of the regions except for a first region, and wherein the apparatus is further caused to perform: deriving the first region to comprise remaining samples in a decoded picture not comprised in a second region with a different region index compared to a region index of the first region. In an example, the second region includes multiple other signaled regions. In an example, the first region comprises a particular region and the different region index comprises a lower region index.

Example 27: The apparatus of any of the examples 15 to 24, wherein the apparatus is further caused to perform: receiving a region identifier for each region, wherein the region identifier enables tracking of the regions across a sequence of multiple pictures.

Example 28: The apparatus of any of the examples 15 to 27, wherein the information message comprises a supplemental enhancement information message.

Example 29: A method comprising: defining or generating an information message for enabling a region-based signaling of quality metric; and when the region-based signaling of the quality metric is enabled, signaling one or more of following: a number of regions in a picture; type of regions; region index method indicator for the regions; a region index for each region; or a measure or value for each quality metric and/or each color component of the each region.

Example 30: The method example 29 further comprising: signaling a flag for indicating whether the region-based signaling of the quality metrics is activated or not.

Example 31: The method of any of the examples 29 or 30 further comprising:
signaling a region type indicator for indicating the type of regions used.

Example 32: The method of any of the examples 29 to 31, wherein the type of regions comprise: one or more picture partitions that are used for partitioning a coded picture; one or more regions defined by other one or more information messages; explicitly signaled rectangles; or polygonal shapes with multiple nodes.

Example 33: The method example 32, wherein the one or more picture partitions comprises: a subpicture, a slice, or a tile.

Example 34: The method of any of the examples 32 or 33, wherein the one or more regions defined by other one or more information messages comprises constituent rectangles, object mask information, or annotated regions, packed regions information, or regional nesting.

Example 35: The method of any of the examples 31 to 34, wherein the region type indicator comprises a region type indicator value intended to be used to determine whether one or more subsequent indicators that define the region are signaled.

Example 36: The method of example 35, wherein when: the region type indicator value indicates that the type of regions used comprise the subpicture, and wherein the method further comprises: signaling a subpicture index; the region type indicator value indicates that the type of regions used comprise the slice, and wherein the method further comprises: signaling a slice index; the region type indicator value indicates that the type of regions used comprise the tile, and wherein the method further comprises: signaling a tile index; the region type indicator value indicates that the type of regions used comprise the constituent rectangles, and wherein the method further comprises: signaling a constituent rectangles index; or the region type indicator value indicates that the type of regions used comprise explicitly signaled rectangles, and wherein the method further comprises: signaling co-ordinates, a width, and a height of the region.

Example 37: The method of any of the examples 36 or 36, wherein the region type indicator value indicates whether a region is defined by another information message and gates one or more subsequent indicators that identify the another information message that defines the region.

Example 38: The method of any of the examples 29 to 35, wherein: when the region index method indicator is equal to a first value, it indicates that the quality metric is applicable for all the regions; when the region index method indicator is equal to a second value, and wherein the method further comprises: signaling a subset of the number of regions; and signaling a region index for each region; and wherein when the region index method indicator is equal to a third value, and wherein the method further comprises: signaling a region index for each of the regions except for a first region, and wherein the first region is intended to be derived to comprise remaining samples in a decoded picture not comprised in a second region with a different region index as compared to a region index of the first region. In an example, the first value comprises zero or is equal to zero; the second value comprises one or is equal to one; and the third value comprises two or is equal to two. In an example, the second region includes multiple other signaled regions. In an example, the first region comprises a particular region and the different region index comprises a lower region index.

Example 39: The method of any of the examples 29 to 35 further comprising: indicating that the quality metric is applicable for all the regions; signaling a subset of the number of regions and a region index for each region; or signaling a region index for each of the regions except for a first region, and wherein the first region is intended to be derived to comprise remaining samples in a decoded picture not comprised in a second region with a different region index compared to a region index of the first region. In an example, the second region includes multiple other signaled regions. In an example, the first region comprises a particular region and the different region index comprises a lower region index.

Example 40: The method of any of the examples 29 to 37 further comprising: signaling a region identifier for each region, wherein the region identifier enables tracking of the regions across a sequence of multiple pictures.

Example 41: The method of any of the examples 29 to 40 further comprising: signaling the information message.

Example 42: The method of any of the examples 29 to 41, wherein the information message comprises a supplemental enhancement information message.

Example 43: A method comprising: receiving an information message enabling region-based processing of quality metric; parsing the information message; and when region-based processing of the quality metric is enabled, extracting one or more of following from the information message; a number of regions in a coded picture; type of regions; region index method indicator for the regions; a region index for each region; or measure or value for each quality metric and/or each color component of the each region.

Example 44: The method of example 43 further comprising: receiving the coded picture; decoding the coded picture to generate a decoded picture; selecting one or more regions in the decoded picture for postprocessing; using the quality metric for indicating a lower quality for the selected one or more regions than quality for the other regions in the decoded picture; and applying postprocessing to the selected one or more regions.

Example 45: The method any of the examples 43 or 44 further comprising: receiving a flag for indicating whether the region-based signaling of the quality metrics is activated or not.

Example 46: The method of any of the examples 43 to 45 further comprising: receiving a region type indicator for indicating the type of regions used.

Example 47: The method of any of the examples 43 to 46, wherein the type of regions comprise: one or more picture partitions that are used for partitioning a coded picture; one or more regions defined by other one or more information messages; explicitly signaled rectangles; or polygonal shapes with multiple nodes.

Example 48: The method example 47, wherein the one or more picture partitions comprises: a subpicture, a slice, or a tile.

Example 49: The method of any of the examples 47 or 48, wherein the one or more regions defined by other one or more information messages comprises constituent rectangles, object mask information, or annotated regions, packed regions information, or regional nesting.

Example 50: The method of any of the examples 46 to 49, wherein the region type indicator comprises a region type indicator value, and wherein the method further comprises: using the region type indicator value for determining whether one or more subsequent indicators that define the region are signaled.

Example 51: The method of example 50, wherein when: the region type indicator value indicates that the type of regions used comprise the subpicture, and wherein the method further comprises: receiving a subpicture index; the region type indicator value indicates that the type of regions used comprise the slice, and wherein the method further comprises: receiving a slice index; the region type indicator value indicates that the type of regions used comprise the tile, and wherein the method further comprises; receiving a tile index; the region type indicator value indicates that the type of regions used comprise the constituent rectangles, and wherein the method further comprises; receiving a constituent rectangles index; or the region type indicator value indicates that the type of regions used comprise explicitly signaled rectangles, and wherein the method further comprises: receiving co-ordinates, a width, and a height of the region.

Example 52: The method of any of the examples 50 or 51, wherein the region type indicator value indicates whether a region is defined by another information message and gates one or more subsequent indicators that identify the another information message that defines the region.

Example 53: The method of any of the examples 43 to 49, wherein: when the region index method indicator is equal to a first value, it indicates that the quality metric is applicable for all the regions; when the region index method indicator is equal to a second value, and wherein the method further comprises: signaling a subset of the number of regions; and signaling a region index for each region; and wherein when the region index method indicator is equal to a third value, and wherein the method further comprises: signaling a region index for each of the regions except for a first region, and wherein the method further comprises: deriving the first region to comprise remaining samples in a decoded picture not comprised in a second region with a different region index as compared to a region index of the first region. In an example, the first value comprises zero or is equal to zero; the second value comprises one or is equal to one; and the third value comprises two or is equal to two. In an example, the second region includes multiple other signaled regions. In an example, the first region comprises a particular region and the different region index comprises a lower region index.

Example 54: The method of any of the examples 43 to 49 further comprising: receiving an indication that the quality metric is applicable for all the regions; receiving a subset of the number of regions and a region index for each region; or receiving a region index for each of the regions except for a first region, and wherein the method further comprises; deriving the first region to comprise remaining samples in a decoded picture not comprised in a second region with a different region index compared to a region index of the first region. In an example, the second region includes multiple other signaled regions. In an example, the first region comprises a particular region and the different region index comprises a lower region index.

Example 55: The method of any of the examples 43 to 51 further comprising: receiving a region identifier for each region, wherein the region identifier enables tracking of the regions across a sequence of multiple pictures.

Example 56: The method of any of the examples 43 to 55, wherein the information message comprises a supplemental enhancement information message.

Example 57: An apparatus comprising means for performing the methods as described in any of the examples 29 to 42.

Example 58: An apparatus comprising means for performing the methods as described in any of the examples 43 to 56.

Example 59: A computer readable medium comprising program instructions that, when executed by an apparatus, cause the apparatus at least to perform the methods as described in any of the examples 29 to 42.

Example 60: The computer readable medium of example 59, wherein the computer readable medium comprises a non-transitory computer readable medium.

Example 61: A computer readable medium comprising program instructions that, when executed by an apparatus, cause the apparatus at least to perform the methods as described in any of the examples 43 to 56.

Example 62: The computer readable medium of example 61, wherein the computer readable medium comprises a non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIG. 5 shows artifact zones in a coded picture represented employing embodiments of the examples described herein.

FIG. 6. shows a signaling message employing embodiments of the examples described herein.

FIG. 7 shows an example apparatus, which may be implemented in hardware, and is caused to, implement examples described herein.

FIG. 8 shows a representation of an example of non-volatile memory media used to store instructions that implement the examples described herein.

FIG. 9 is an example method performed with an encoder, based on the examples described herein.

FIG. 10 is an example method performed with a decoder, based on the examples described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):

| | |
|---|---|
| 5G | fifth generation cellular network technology |
| DSP | digital signal processor |
| LTE | long-term evolution |
| RFC | request for comments |

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for enabling region specific quality metrics in video processing.

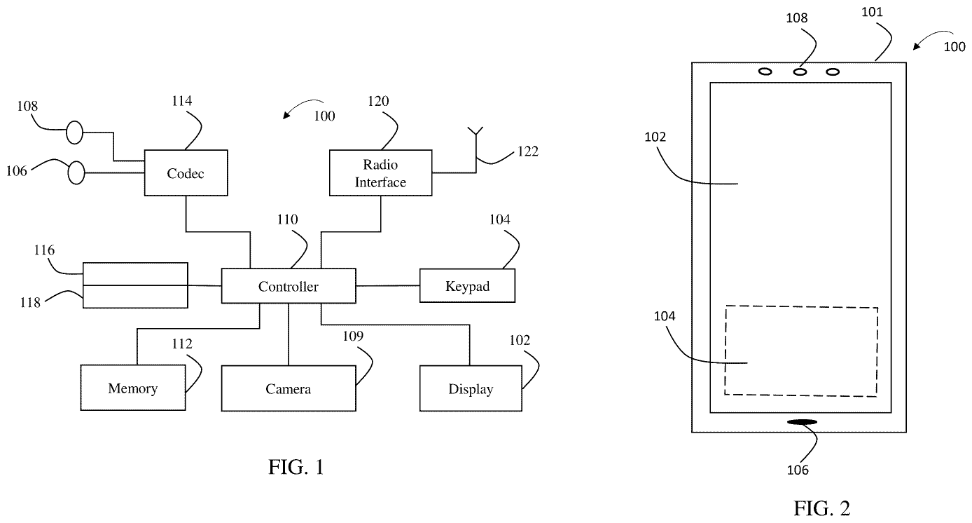

The following describes in detail a suitable apparatus and possible method for enabling region specific quality metrics in video processing according to embodiments. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a universal integrated circuit card (UICC) and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

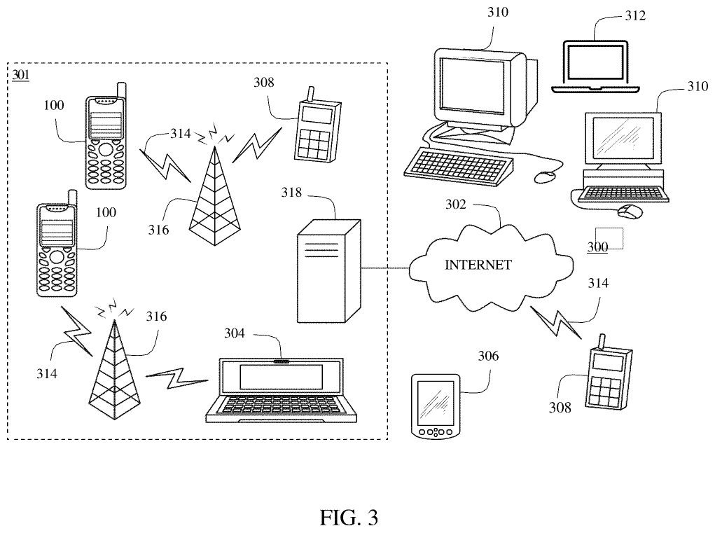

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a Global System for Mobile Communications (GSM), Universal Mobile Telecommunications System (UMTS), Code Division Multiple Access (CDMA), Long Term Evolution (LTE), fourth generation (4G), fifth generation (5G) network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

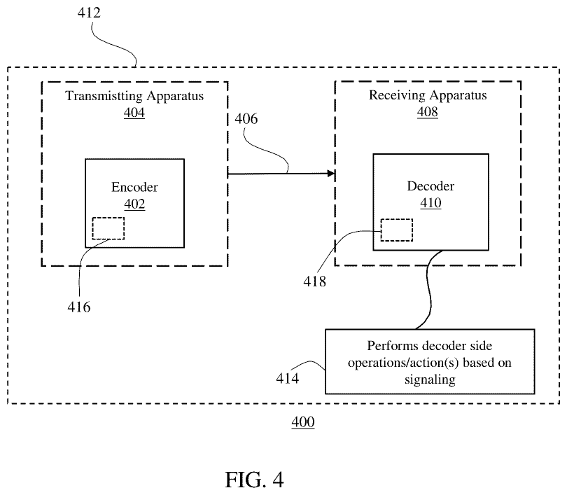

FIG. 4 is a block diagram illustrating a system or apparatus 400 in accordance with several examples. In an example, the encoder 402 is used to encode an image or video, and the encoder 402 may be implemented in a transmitting apparatus 404. The encoder 402 produces a bitstream 406 comprising signaling that is received by the receiving apparatus 408, which implements a decoder 410. The encoder 402 sends the bitstream 406 that comprises the herein described signaling. The decoder 410 forms the image or video, and the receiving apparatus 408 may present this to the user, e.g., via a smartphone, television, or projector among many other options.

In some examples, the encoder 402 may reside in a separate apparatus from the transmitting apparatus 404. In some examples, the apparatus comprising the encoder 402 may be connected to the transmitting apparatus 404, e.g., through a memory bus. In some examples, the encoder 402 may produce the bitstream 406 that is stored, e.g. in a mass memory.

In some examples, the decoder 410 may reside in a separate apparatus from the receiving apparatus 408. In some examples, the apparatus comprising the decoder 410 may be operationally connected to the receiving apparatus 408, e.g., through a memory bus. In some examples, the decoder 410 may obtain the bitstream 406 from a mass memory.

In some examples, the transmitting apparatus 404 and the receiving apparatus 408 are at least partially within a common apparatus, and for example, are located within a common housing 412. For example, the common apparatus comprising the encoder 402 and decoder 410 implements a codec. In other examples, the encoder 402 and the decoder 410 are at least partially not within a common apparatus and have at least partially different housings, but when together, may still implement a codec.

As indicated at 414, the decoder 410 performs an operation(s) or action(s) based on the received signaling.

In some examples, encoding 416 performs generating and/or signaling of region specific quality metrics, based on example described herein. In some examples, decoding 418 performs receiving and/or processing of region specific quality metrics in video processing, based on the examples described herein.

Having thus introduced a suitable but non-limiting technical context for the practice of the example embodiments of the present disclosure, example embodiments will now be described in detail.

Various embodiments of the disclosure propose enabling new functionalities in an existing SEI message specified in JVET-AK2032 “Technologies under Consideration for future versions of VSEI (version 7)”.

The supplemental enhancement information (SEI) message is related to Quality Metrics (QM).

### QM SEI

The Quality Metrics (QM) SEI message is currently included in JVET-AK2032 “Technologies under Consideration for future versions of VSEI (version 7)”. It enables to carry information about images quality using one or several metrics.

Under its current design, it enables to signal a set of quality metrics value for every colour component of a picture. It can also indicate coded layer video sequence (CLVS) average quality or per picture quality metrics.

### Green Moving Picture Experts Group (MPEG)

The ISO/IEC 23001-11 specifies energy efficient media consumption metadata. It defines a green metadata SEI that can be provided together with a video bitstream to enable various type of energy reduction in the device or in the network.

Firstly, green MPEG enables signaling of complexity related information, per indicating statistics on coded blocks (e.g. percentage of non-zero residuals, of SAO instances, etc.) and other metrics. The period types can be the following, as described in Table 1:

TABLE 1
specification of period_type for advanced video coding (AVC)

| Value | Description |
|---|---|
| 0x00 | complexity metrics are applicable to a single picture |
| 0x01 | complexity metrics are applicable to all pictures in decoding order, up to (but |
| | not including) the picture containing the next I slice |
| 0x02 | complexity metrics are applicable over a specified time interval in seconds |
| 0x03 | complexity metrics are applicable over a specified number of pictures counted |
| | in decoding order |
| 0x04 | complexity metrics are applicable to a single picture with slice granularity |
| 0x05 | complexity metrics are applicable to a single picture with scalable layer |
| | granularity |
| 0x06 | complexity metrics are applicable to all pictures in decoding order, up to (but |
| | not including) the picture containing the next I slice in the base layer with |
| | scalable layer granularity |
| 0x07 | complexity metrics are applicable over a specified time interval in seconds |
| | with scalable layer granularity |
| 0x08 | complexity metrics are applicable over a specified number of pictures counted |
| | in decoding order with scalable layer granularity |
| 0x09-0xFF | user-defined |

Green MPEG allows metrics to be signaled at picture, subpicture, slice, or tile granularity. Table 2 describes specification of granularity for versatile video coding (VVC).

| Value | Description |
|---|---|
| 0x0 | complexity metrics are applicable to picture granularity |
| 0x1 | complexity metrics are applicable to sub-picture granularity |
| 0x2 | complexity metrics are applicable to slice granularity |
| 0x3 | complexity metrics are applicable to tile granularity |
| 0x4-0x7 | user-defined |

In the current design of the QM SEI, the quality metrics can be signaled per frame, or as an average value for a set of multiples frames. However, many post-processing applications tends to enhance only a part of the picture, e.g., the boundaries, ringing artifacts in the sky, or blocking artifacts in grass. To achieve such region-specific enhancements, content is analyzed to identify the different regions and metrics are computed assessing whether processing would be beneficial or not. Leveraging the QM SEI message to achieve such use-case is impossible with the current design as there is now way of carrying region-specific metrics.

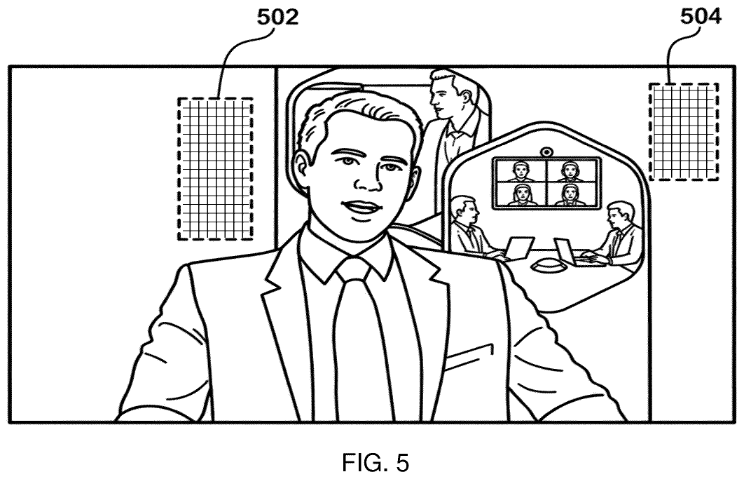

QM SEI is useful to indicate receivers the potential types of visual degradation in a picture, or a CLVS, enabling the receiver to apply relevant processing. In cases where artifacts are localized in the content, the presence cannot be captured well with a per frame or a per CLVS average metrics. Thus, it is needed to enable more flexible quality metrics signaling. FIG. 5 shows artifact zones in a coded picture represented employing embodiments of the examples described. The example illustrated in FIG. 5 would benefit from enabling localized quality metric signaling in QM SE. FIG. 5 is shown to include two example blocking artifact zones, e.g., blocking artifact zone A 502 and blocking artifact zone B 504.

Various embodiment of the disclosure provide at least the following features to the QM SEI:
Enablement of region-specific quality metrics
When region-signaling is enabled:
   Signaling the number of regions;
   Signaling the type of regions (subpicture, constituent rectangles, explicit rectangles, etc.);
   Signaling an inference method indicator for the region;
   Signaling of the region index, for every region; and/or
   Signaling the quality metric for every metric and every colour component of each region; and/or
   Signaling the quality metric for every metric and every colour component of the remaining region (e.g., remaining samples not included in any of the signaled regions).

In one embodiment, a flag is signaled, indicating if region-based signaling of quality metrics is activated or not.

In an embodiment, an indicator of the type of region is signaled, indicating what type of region is used. Some examples of the regions may include, but are not limited to, following:
One or more picture partitions that are used for partitioning a coded picture, such as:
   Subpicture;
   Slice; or
   Tile;
One or more regions defined by other SEI message(s), such as:
   Constituent rectangles (e.g., as specified in JVET-AK2032 “Technologies under Consideration for future versions of VSEI (version 7)”);
   Object Mask Information (e.g., as specified in JVET-AK2006 “Additional SEI messages for VSEI version 4”);
   Annotated Regions (e.g., as specified in the VSEI standard or in the HEVC standard); or
   Packed Regions Information (e.g., as specified in JVET-AK2006 “Additional SEI messages for VSEI version 4”);
Regional Nesting (e.g., as specified in HEVC);
Explicitly signaled rectangles; and/or
More complex polygonal shapes with multiple nodes.

In an embodiment, a region type indicator indicates a category of the regions and the region type indicator value is used to determine when one or more subsequent indicators that define the region are signaled. In an example embodiment, when the region type indicator indicates subpicture category, the subpicture index is signaled. In another example embodiment, when the region type indicator indicates constituent rectangles category, the constituent rectangles index is signaled. When the region type indicator indicates explicitly signaled rectangles, the (x, y) position and width and height of the region are signaled.

In an example embodiment, an indication of the type indicates that a region is defined by another SEI message and gates subsequent one or more indicators that identify the SEI message that defines the one or more regions. The subsequent indicators may, for example, comprise a payload type value of an SEI message that defines the one or more regions. In another example, the subsequent indicators may comprise a payload type value and an SEI message prefix, which may comprise one or more initial syntax elements of the SEI message syntax for the given payload type value, wherein the initial syntax elements may, for example, comprise an identifier syntax element.

In an example embodiment, when an indication of the type indicates that a region is defined by another SEI message, that another SEI message that defines the type may refer to sample values to define the one or more regions, as described in that another SEI message. For example, an object mask information SEI message may refer to a scalability layer that comprises the sample arrays defining the objects masks.

In an example embodiment, an indication of the type indicates that a region is defined by another SEI message and gates subsequent one or more region indicators that identify the one or more regions in relation to that another SEI message. For example, region indicators may comprise object mask identifier value(s) for the objects which are described in the object mask information SEI message and for which the quality metrics is derived. In another example region indicators may comprise object index(es) for the object bounding boxes which are described in the annotated regions SEI message and for which the quality metrics is derived.

In an embodiment, an indicator of the region index method for the region is signaled. When equal to 0 it indicates that a quality metric is provided for all regions (of type of region indicated by the region type indicator), removing the need for explicit signaling of an index for every region. When the region index method indicator is equal to 1, only a subset of the number of regions is signaled, with a region index signaled for each region. When the region index method indicator is equal to 2, a region index is signaled for each of the regions except for the last region, and the last region is derived to contain all remaining samples in the decoded picture not contained in a region with a lower region index.

Other indicator values for the region index method indicator may be used.

In an embodiment, a region identifier can be signaled for every region, enabling tracking of a same regions across a sequence of multiple frames.

In an embodiment, a receiver/decoder selects one or more regions in the decoded picture for postprocessing, based on the selected regions having a quality metric indicating lower quality than for the other regions, and applies postprocessing only to the selected regions.

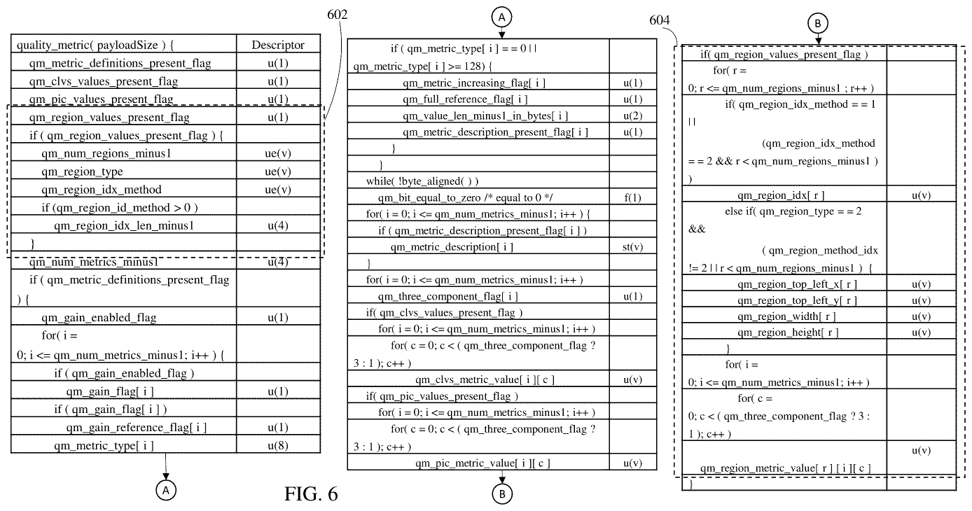

FIG. 6 shows a signaling message employing embodiments of the examples described herein. Modifications to the signaling message or syntax structure are shown at 602 and 604.

Example semantics are provided below:

qm_clvs_values_present_flag equal to 1 specifies that qm_clvs_metric_value[i][c] syntax elements are present. qm_clvs_values_present_flag equal to 0 specifies qm_clvs_metric_value[i][c] syntax elements are not present.

qm_pic_values_present_flag equal to 1 specifies that qm_pic_metric_value[i][c] syntax elements are present. qm_pic_values_present_flag equal to 0 specifies that qm_pic_metric_value[i][c] syntax elements are not present.

qm_region_values_present_flag equal to 1 specifies that qm_region_metric_value[r][i][c] syntax elements are present. qm_region_values_present_flag equal to 0 specifies that qm_region_metric_value[r][i][c] syntax elements are not present.

It is constrained that at least one of the values of qm_metric_definitions_present_flag, qm_clvs_values_present_flag, and qm_pic_values_present_flag, and qm_region_values_present_flag shall be equal to 1.

qm_num_regions_minus1 plus 1 specifies the number of regions for which quality metric entries are signaled.

qm_region_type equal to 0 specifies that regions are coded as subpictures. qm_region_type equal to 1 specifies that regions are coded as constituent rectangles. qm_region_typec equal to 2 specifies that regions are explicitly signaled. The value of qm_region_type shall be in the range of 0 to 2, inclusive, in bitstreams conforming to this version of this. The values of 3 to 15, inclusive, for qm_region_type are reserved for future use by ITU-T|ISO/IEC. Although the value of qm_region_type is required to be in the range of 0 to 2, inclusive, in this version of this Specification, decoders shall also allow values of qm_region_type in the range of 3 to 15, inclusive, to appear in the syntax. Decoders conforming to this version of this Specification shall ignore the bits that follow a value of qm_region_type in the range of 3 to 15, inclusive, in the QMI SEI message.

qm_region_idx_method equal to 0 indicates that the constituent rectangle or subpicture index is inferred from the loop index. qm_region_idx_method equal to 1 indicates that the qm_region_idx[r] syntax element is present. qm_region_method_idc equal to 2 indicates that qm_region_idx[qm_num_metrics_minus1] represents the remaining samples of the picture not represented by the regions represented by an n-th region, for n in 0 . . . qm_num_regions_minus1-1. Although the value of qm_region_idx_method is required to be in the range of 0 to 2, inclusive, in this version of this Specification, decoders shall also allow values of qm_region_idx_method in the range of 3 to 15, inclusive, to appear in the syntax. Decoders conforming to this version of this Specification shall ignore the bits that follow a value of qm_region_idx_method in the range of 3 to 15, inclusive, in the QMI SEI message.

qm_region_idx_len_minus1 plus 1 specifies the length of the qm_region_idx[r] syntax elements in bits.

qm_region_idx[r], when present and qm_region_type_flag equal to 1, specifies the constituent rectangle index that represents the r-th region. qm_region_idx[r], when present and qm_region_type_flag equal to 0, specifies the subpicture index of the r-th region. The length of the syntax element is qm_region_id_len.

When not present and qm_region_method_idc equal to 0, the value of qm_region_idx[r] is inferred to be equal to r.

When not present and qm_region_method_idc equal to 2, the r-th region contains all samples of the picture that are not represented by an n-th region, for n in 0 . . . qm_num_regions_minus1−1.

qm_region_top_left_x[r] and qm_region_top_left_y[r], when present, specify the top left x and y coordinates, respectively, of the r-th region.

qm_region_width[r] and qm_region_height[r], when present, specify the width and height, respectively, of the r-th region.

When qm_region_type is equal to 2, it is a requirement of bitstream conformance that qm_region_top_left_x[r]+qm_region_width[r] is in the range of 0 . . . . PicWidth and qm_region_top_left_x[r]+qm_region_height[r] is in the range of 0 . . . . PicHeight.

qm_region_metric_value[r][i][c] specifies the value of the i-th quality metric for the c-th component of the r-th region of the current picture. The length of the syntax element is 8*(qm_value_len_minus1_in_bytes[I]+1) bits. When r is equal to qm_num_regions_minus1+1, the qm_region_metric_value[r][i][c] specifies the value of the i-th quality for the c-th component of the remaining region in the coded picture.

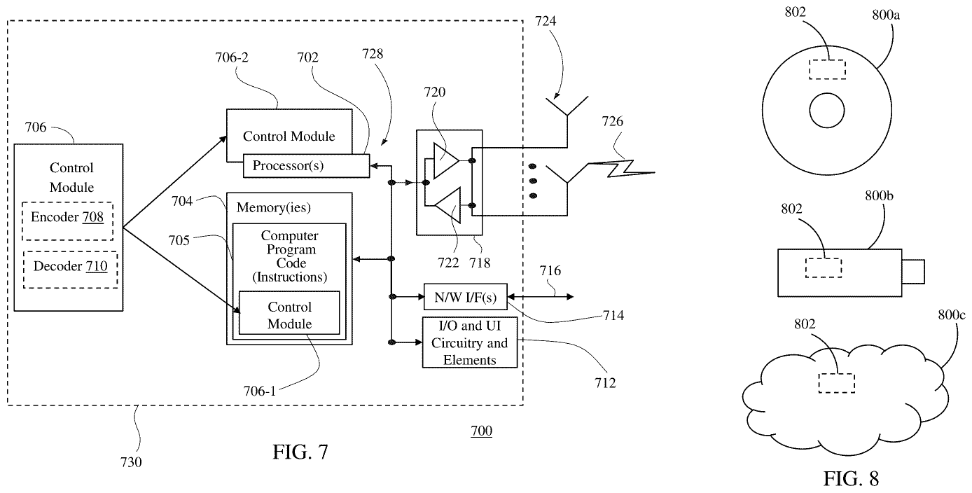

FIG. 7 shows an example apparatus 700, which may be implemented in hardware, configured to implement the examples described herein. The apparatus 700 comprises at least one processor 702 (e.g., an FPGA and/or CPU), at least one memory 704 including computer program code 705, the computer program code 705 having instructions to carry out the methods described herein, wherein the at least one memory 704 and the computer program code 705 are configured to, with the at least one processor 702, cause the apparatus 700 to implement circuitry, a process, component, module, or function (implemented with control module 706) to implement the examples described herein, including enabling region specific quality metrics. Optionally included encoder 708 of the control module 706 implements encoding based on the examples described herein, and optionally included decoder 710 implements decoding based on the examples described herein. The at least one memory 704 may be a non-transitory memory, a transitory memory, a volatile memory (e.g. RAM), or a non-volatile memory (e.g., ROM).

The apparatus 700 includes a display and/or I/O interface 712, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 700 includes one or more communication e.g. network (N/W) interfaces (I/F(s)) 714. The communication I/F(s) 714 may be wired and/or wireless and communicate over the Internet/other network(s) via any communication technique including via one or more links 716. The communication I/F(s) 714 may comprise one or more transmitters or one or more receivers.

The transceiver 718 comprises one or more transmitters 720 and one or more receivers 722. The transceiver 718 and/or communication I/F(s) 714 may comprise standard well-known components such as an amplifier, filter, frequency-converter, (de) modulator, and encoder/decoder circuitries and one or more antennas, such as antennas 724 used for communication over wireless link 726.

The control module 706 of the apparatus 700 comprises one of or both parts 706-1 and/or 706-2, which may be implemented in a number of ways. The control module 706 may be implemented in hardware as control module 706-1, such as being implemented as part of the at least one processor 702. The control module 706-1 may be implemented also as an integrated circuit or through other hardware such as a programmable gate array. In another example, the control module 706 may be implemented as control module 706-2, which is implemented as computer program code (having corresponding instructions) 705 and is executed by the at least one processor 702. For instance, the at least one memory 704 store instructions that, when executed by the at least one processor 702, cause the apparatus 700 to perform one or more of the operations as described herein. Furthermore, the at least one processor 702, the at least one memory 704, and example algorithms (e.g., as flowcharts and/or signaling diagrams), encoded as instructions, programs, or code, are means for causing performance of the operations described herein.

The apparatus 700 to implement the functionality of control module 706 may correspond to any of the apparatuses depicted herein. Alternatively, apparatus 700 and its elements may not correspond to any of the other apparatuses depicted herein, as apparatus 700 may be part of a self-organizing/optimizing network (SON) node or other node, such as a node in a cloud.

The apparatus 700 may also be distributed throughout the network including within and between apparatus 700 and any network element (such as a base station and/or terminal device and/or user equipment).

Interface 728 enables data communication and signaling between the various items of apparatus 700, as shown in FIG. 7. For example, the interface 728 may be one or more buses such as address, data, or control buses, and may include any interconnection mechanism, such as a series of lines on a motherboard or integrated circuit, fiber optics or other optical communication equipment, and the like. Computer program code (e.g. instructions) 705, including control module 706 may comprise object-oriented software configured to pass data or messages between objects within computer program code 705. The apparatus 700 need not comprise each of the features mentioned, or may comprise other features as well. The various components of apparatus 700 may at least partially reside in a housing 730, or a subset of the various components of apparatus 700 may at least partially be located in different housings, which different housings may include housing 730.

FIG. 8 shows a schematic representation of non-volatile memory media 800a (e.g. computer/compact disc (CD) or digital versatile disc (DVD)) and 800b (e.g. universal serial bus (USB) memory stick) and 800c (e.g. cloud storage for downloading instructions and/or parameters 802 or receiving emailed instructions and/or parameters 802) storing instructions and/or parameters 802 which when executed by a processor allows the processor to perform one or more of the operations of the methods described herein. Instructions and/or parameters 802 may represent or correspond to a non-transitory computer readable medium.

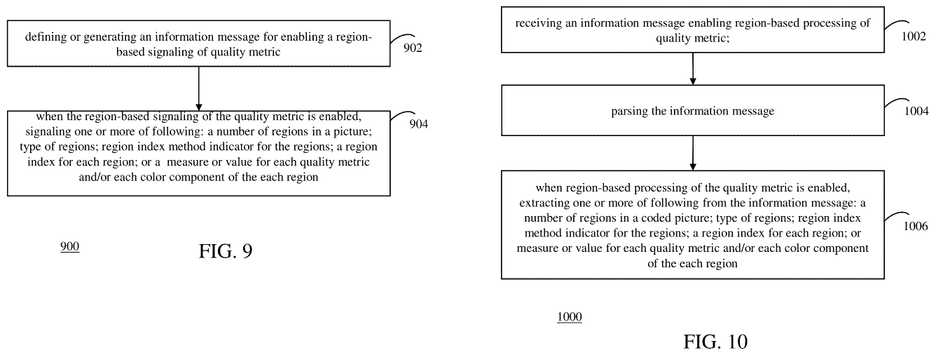

FIG. 9 is an example method 900 performed with an encoder, based on the examples described herein. At 902, the method 900 includes defining or generating an information message for enabling a region-based signaling of quality metric. At 904, the method 900 includes, when the region-based signaling of the quality metric is enabled, signaling one or more of following: a number of regions in a picture; type of regions; region index method indicator for the regions; a region index for each region; or a measure or value for each quality metric and/or each color component of the each region.

The method 900 may be performed with an encoding apparatus, such as the apparatus 100, 700, or apparatuses depicted in FIG. 3 and FIG. 4, for example, the transmitting apparatus 404 with the encoder 402, or the apparatus 400 with the encoder 402.

FIG. 10 is an example method 1000 performed with a decoder, based on the example embodiments described herein. At 1002, the method 1000 includes receiving an information message enabling region-based processing of quality metric. At 1004, the method 1000 includes parsing the information message. At 1006, the method 1000 includes when region-based processing of the quality metric is enabled, extracting one or more of following from the information message: a number of regions in a coded picture; type of regions; region index method indicator for the regions; a region index for each region; or measure or value for each quality metric and/or each color component of the each region.

The method 1000 may be performed with a decoding apparatus, such as the apparatus 100, 700, or apparatuses depicted in FIG. 3 and FIG. 4, for example, the receiving apparatus 408 with the decoder 410, or the apparatus 400 with the decoder 410.

As described above, FIGS. 9 and 10 include flowcharts of an apparatus (e.g. 100, 400, 700, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 112 or 704) of an apparatus employing an embodiment of the present invention and executed by processing circuitry (e.g., 110 or 702) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 9 and 10. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some example embodiments have been described in relation to specific terms applicable to a particular format or standard. It is to be understood that embodiments may be similarly realized with any terms with similar semantics. For example, some embodiments have been described in relation to one or more SEI messages, but embodiments may be similarly realized with one or more metadata OBUs.

Some example embodiments have been described in relation to picture partitions, such as subpictures, slices, and tiles. It is to be understood that embodiments may be similarly realized with any other image segments, such as tile groups.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
defining or generating an information message for enabling a region-based signaling of a quality metric; and
when the region-based signaling of the quality metric is enabled, signaling one or more of following:
a number of regions in a picture;
type of regions;
region index method indicator for the regions;
a region index for each of the regions; or
a measure or value for each quality metric and/or each color component of the each region.

2. The apparatus of claim 1, wherein the apparatus is further caused to perform: signaling a flag for indicating whether the region-based signaling of the quality metric is activated or not.

3. The apparatus of claim 1, wherein the apparatus is further caused to perform: signaling a region type indicator for indicating the type of regions used.

4. The apparatus of claim 1, wherein the type of regions comprise:
one or more picture partitions that are used for partitioning a coded picture;
one or more regions defined by other one or more information messages;
explicitly signaled rectangles; or
polygonal shapes with multiple nodes.

5. The apparatus of claim 1, wherein one or more regions defined by other one or more information messages comprises constituent rectangles, object mask information, or annotated regions, packed regions information, or regional nesting.

6. The apparatus of claim 3, wherein the region type indicator comprises the region type indicator comprises a region type indicator value intended to be used to determine whether one or more subsequent indicators that define the region are signaled, and wherein when:
the region type indicator value indicates that the type of regions used comprise a subpicture, and wherein the apparatus is further caused to perform: signaling a subpicture index;
the region type indicator value indicates that the type of regions used comprise a slice, and wherein the apparatus is further caused to perform: signaling a slice index;
the region type indicator value indicates that the type of regions used comprise a tile, and wherein the apparatus is further caused to perform: signaling a tile index;
the region type indicator value indicates that the type of regions used comprise constituent rectangles, and wherein the apparatus is further caused to perform: signaling a constituent rectangles index; or
the region type indicator value indicates that the type of regions used comprise explicitly signaled rectangles, and wherein the apparatus is further caused to perform: signaling co-ordinates, a width, and a height of the region.

7. The apparatus claim 6, wherein the region type indicator value indicates whether a region is defined by another information message and gates one or more subsequent indicators that identify the another information message that defines the region.

8. The apparatus of claim 1, wherein:
when the region index method indicator is equal to a first value, it indicates that the quality metric is applicable for all the regions;
when the region index method indicator is equal to a second value, and wherein the apparatus is further caused to perform:
signaling a subset of the number of regions; and
signaling the region index for each of the regions; and
wherein when the region index method indicator is equal to a third value, and wherein the apparatus is further caused to perform:
signaling the region index for each of the regions except for a first region, and wherein the first region is intended to be derived to comprise remaining samples in a decoded picture not comprised in a second region with a different region index as compared to a region index of the first region.

9. The apparatus of claim 1, wherein the apparatus is further caused to perform:
indicating that the quality metric is applicable for all the regions;
signaling a subset of the number of regions and the region index for each of the regions;
or
signaling the region index for each of the regions except for a first region, and wherein the first region is intended to be derived to comprise remaining samples in a decoded picture not comprised in a second region with a different region index compared to a region index of the first region.

10. The apparatus of claim 1, wherein the apparatus is further caused to perform: signaling a region identifier for each region, wherein the region identifier enables tracking of the regions across a sequence of multiple pictures.

11. An apparatus comprising:
at least one processor; and
at least one memory storing instructions that, when executed by the at least one processor, cause the apparatus at least to perform:
receiving an information message enabling region-based processing of quality metric;
parsing the information message; and
when region-based processing of the quality metric is enabled, extracting one or more of following from the information message:
a number of regions in a coded picture;
type of regions;
region index method indicator for the regions;
a region index for each region; or
measure or value for each quality metric and/or each color component of the each region.

12. The apparatus of claim 11, wherein the apparatus is further caused to perform:
receiving the coded picture;
decoding the coded picture to generate a decoded picture;
selecting one or more regions in the decoded picture for postprocessing;
using the quality metric for indicating a lower quality for the selected one or more regions than quality for other regions in the decoded picture; and
applying postprocessing to the selected one or more regions.

13. The apparatus claim 11, wherein the apparatus is further caused to perform: receiving a flag for indicating whether the region-based signaling of the quality metric is activated or not.

14. The apparatus of claim 11, wherein the apparatus is further caused to perform:
receiving a region type indicator for indicating the type of regions used.

15. The apparatus of claim 11, wherein the type of regions comprise:
one or more picture partitions that are used for partitioning the coded picture;
one or more regions defined by other one or more information messages;
explicitly signaled rectangles; or
polygonal shapes with multiple nodes.

16. The apparatus of claim 14, wherein the region type indicator comprises a region type indicator value, and wherein the apparatus is further caused to perform: using the region type indicator value for determining whether one or more subsequent indicators that define the region are signaled, and wherein when:
the region type indicator value indicates that the type of regions used comprise a subpicture, the apparatus is further caused to perform: receiving a subpicture index;
the region type indicator value indicates that the type of regions used comprise a slice, the apparatus is further caused to perform: receiving a slice index;
the region type indicator value indicates that the type of regions used comprise a tile, the apparatus is further caused to perform: receiving a tile index;
the region type indicator value indicates that the type of regions used comprise constituent rectangles, the apparatus is further caused to perform: receiving a constituent rectangles index; or
the region type indicator value indicates that the type of regions used comprise explicitly signaled rectangles, the apparatus is further caused to perform: receiving co-ordinates, a width, and a height of the region.

17. The apparatus of claim 16, wherein the region type indicator value indicates whether a region is defined by another information message and gates one or more subsequent indicators that identify the another information message that defines the region.

18. The apparatus of claim 11, wherein:
when the region index method indicator is equal to a first value, it indicates that the quality metric is applicable for all the regions;
when the region index method indicator is equal to a second value, and wherein the apparatus is further caused to perform:
signaling a subset of the number of regions; and
signaling the region index for each of the regions; and
wherein when the region index method indicator is equal to a third value, and wherein the apparatus is further caused to perform:
signaling the region index for each of the regions except for a first region, and wherein the apparatus is further caused to perform: deriving the first region to comprise remaining samples in a decoded picture not comprised in a second region with a different region index as compared to a region index of the first region.

19. The apparatus of claim 11, wherein the apparatus is further caused to perform:
receiving an indication that the quality metric is applicable for all the regions;
receiving a subset of the number of regions and the region index for each of the regions;
or
receiving the region index for each of the regions except for a first region, and wherein the apparatus is further caused to perform: deriving the first region to comprise remaining samples in a decoded picture not comprised in a second region with a different region index compared to a region index of the first region.

20. The apparatus of claim 11, wherein the apparatus is further caused to perform:
receiving a region identifier for each region, wherein the region identifier enables tracking of the regions across a sequence of multiple pictures.
